(19) United States
(12) Patent Application Publication
(10) Pub. No.: US 2023/0184939 A1
(43) Pub. Date: Jun. 15, 2023

(54) Proximity sensor utilizing optical fibers

(71) Applicant: Apple Inc., Cupertino, CA (US)

(72) Inventors: Yazan Z. Alnahhas, Mountain View, CA (US); Eamon H. O'Connor, San Jose, CA (US); Jianmin Gong, San Jose, CA (US); Matthew C. Waldon, San Francisco, CA (US); Mauro O. Magnaghi, San Jose, CA (US); Meng Zhang, Cupertino, CA (US); Prabhakar Gulgunje, Cupertino, CA (US); Wei Lin, Santa Clara, CA (US); Yohai Zmora, San Francisco, CA (US)

(21) Appl. No.: 17/549,917

(22) Filed: Dec. 14, 2021

(51) Int. Cl. G01S 17/10; G01S 7/4865; G02B 6/02

(52) U.S. Cl. CPC G01S 17/10; G01S 7/4865; G02B 6/02033

(57) ABSTRACT

A proximity sensor includes a light source configured to emit a beam of optical radiation and a detector configured to output an electrical signal in response to the optical radiation that is incident on the detector. A first optical multimode fiber is configured to receive the emitted beam and to direct the emitted beam toward an object. A second optical multimode fiber is configured to receive the optical radiation reflected from the object and to convey the received optical radiation to the detector. A processor is coupled to process the electrical signal so as to compute a distance to the object.

### FIELD OF THE INVENTION

The present invention relates generally to optical sensing, and particularly to devices and methods for optical proximity sensing.

### BACKGROUND

Portable electronic devices may comprise an optical proximity sensor for measuring the distance from the portable device to an object, with a typical distance not exceeding 100 cm. Some proximity sensors use a light detection and ranging (LiDAR sensor), such as a direct time-of-flight (ToF) sensor.

In a direct ToF sensor, a light source, such as a pulsed laser, directs pulses of optical radiation toward an object, and a high-speed detector senses the time of arrival of the radiation reflected from the object. (The terms “light” and “illumination,” as used in the context of the present description and in the claims, refer to optical radiation in any or all of the visible, infrared, and ultraviolet ranges.) The range is computed from the time delay between the emission time of the outgoing pulse and the arrival time of the reflected pulse from the object, which is referred to as the “time of flight” of the optical pulses.

### SUMMARY

Embodiments of the present invention that are described hereinbelow provide improved methods and devices for proximity sensing.

There is therefore provided, in accordance with an embodiment of the invention, a proximity sensor, which includes a light source configured to emit a beam of optical radiation and a detector configured to output an electrical signal in response to the optical radiation that is incident on the detector. A first optical multimode fiber is configured to receive the emitted beam and to direct the emitted beam toward an object. A second optical multimode fiber is configured to receive the optical radiation reflected from the object and to convey the received optical radiation to the detector. A processor is coupled to process the electrical signal so as to compute a distance to the object.

Typically, the distance does not exceed 100 cm. In a disclosed embodiment, the light source is configured to output pulses of the optical radiation, and the electrical signal output by the detector is indicative of a time of flight of the optical pulses, and the processor is configured to compute the distance to the object based on the time of flight.

In some embodiments, the first and second optical multimode fibers include plastic optical fibers. In the disclosed embodiments, each of the plastic optical fibers includes a core including a core material selected from a first list consisting of polymethylmethacrylate (PMMA), polycarbonate (PC), polyester (PE), polyethylene terephthalate glycol-modified (PETg), and cyclic olefin polymer (COP), and at least one cladding including at least one cladding material selected from a second list consisting of polyvinylidene difluoride (PVDF), a terpolymer including ethylene, tetrafluoroethylene, and hexafluoropropylene, PMMA, PETg, PC, polystyrene (PS), COP, and co-polymers of these polymers. In one embodiment, the core includes PMMA, and the at least one cladding includes a first cladding including PVDF and a second cladding including PMMA.

Additionally or alternatively, each of the first and second optical multimode fibers includes a respective plurality of multimode sub-fibers. In one embodiment, each sub-fiber includes a core and at least one cladding.

In the disclosed embodiments, the numerical aperture (NA) of each of the first and second optical multimode fibers does not exceed 0.5. In one embodiment, the NA of each of the first and second optical multimode fibers does not exceed 0.2.

In another embodiment, at least one of the first and second optical multimode fibers is bent so as to deviate from a straight line.

In a disclosed embodiment, the first optical multimode fiber is configured to direct the beam of the optical radiation toward the object through a cover glass, and the second optical multimode fiber is configured to receive the optical radiation reflected from the object through the cover glass.

There is also provided, in accordance with an embodiment of the invention, a method for proximity sensing, which includes directing a beam of optical radiation from a light source through a first optical multimode fiber toward an object. The optical radiation reflected from the object is received in a second optical multimode fiber and conveyed through the second optical multimode fiber to a detector. An electrical signal output by the detector in response to the received optical radiation is processed so as to compute a distance to the object.

The present invention will be more fully understood from the following detailed description of the embodiments thereof, taken together with the drawings in which:

### BRIEF DESCRIPTION OF THE DRAWINGS

FIG. 1 is a schematic sectional view of an optical proximity sensor, in accordance with an embodiment of the invention;

FIGS. 2A and 2B are schematic longitudinal sectional views of optical fibers, in accordance with embodiments of the invention;

FIGS. 3A, 3B, and 3C are schematic partial sectional views of proximity sensors, in accordance with embodiments of the invention;

FIG. 3D is a cross-sectional view of a multi-core optical fiber, in accordance with an embodiment of the invention; and

FIG. 4 is a schematic sectional view of a proximity sensor, in accordance with another embodiment of the invention.

### DETAILED DESCRIPTION OF EMBODIMENTS

Portable electronic devices typically contain multiple accessories, such as cameras, light sources, and proximity sensors, which are directed toward the area in front of the device. These accessories reduce the area that is available for the display screen of the device. It is thus desirable to reduce the areas of the front surface of the device that are consumed by the proximity sensor and other accessories. At the same time, reducing the area of the proximity sensor, for example, is liable to increase crosstalk between the transmit and receive channels, meaning that a larger part of the optical radiation emitted by the light source of the proximity sensor is reflected (for example from a cover glass over the sensor) directly into the detector of the sensor, thus degrading the sensing accuracy.

To address these problems in embodiments of the present invention, the light source and detector of the proximity sensor are distanced from the cover glass. A first optical fiber conveys the optical radiation from the light source to the cover glass and directs the radiation toward the object. A second optical fiber receives the optical radiation that is reflected from the object through the cover glass and conveys the received radiation to the detector. Thus, the bulk of the proximity sensor is positioned away from the frontal area of the portable electronic device, with only the ends of the optical fibers requiring “real estate” in the frontal area.

To improve optical performance in some embodiments of the present invention, the optical fibers used in the proximity sensor are multimode fibers, for example plastic optical fibers. These multimode fibers provide a large optical aperture for ease of alignment, with a numerical aperture (NA) large enough to transmit and capture optical radiation over the angular range of interest. The fibers are constructed, however, so as to have an NA not exceeding 0.5, and in some embodiments even 0.2 or less, so as to minimize the optical crosstalk between the transmit and receive fibers.

Thus, in the disclosed embodiments, an optical sensing device comprises a light source, which emits a beam of optical radiation. A first optical fiber receives the emitted beam and conveys it toward an object. A second optical fiber receives optical radiation reflected by the object and conveys the reflected radiation to a detector, which outputs an electrical signal in response to the optical radiation that is incident thereon. A processor processes the electrical signal in order to compute a distance to the object.

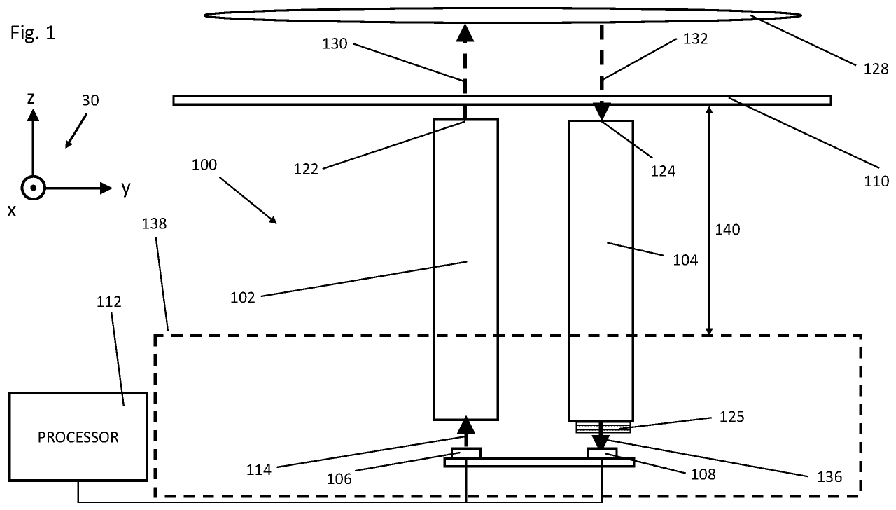

FIG. 1 is a schematic pictorial view of an optical proximity sensor 100, in accordance with an embodiment of the invention. Sensor 100 may be incorporated, for example, in a portable electronic device, in order to sense the proximity of an object 128 (such as the face of a user) to the device. Alternatively, sensor 100 may be used in substantially any other application requiring detection of objects in close proximity, for example less than 100 cm from the sensor, or possibly less than 30 cm, or even less than 10 cm from the sensor. (In FIG. 1, the size of sensor 100 and the distance to object 128 are not to scale.) Proximity sensor 100 in this example is configured as a direct ToF sensor, but alternatively, the principles of the present invention may be applied to optical proximity sensors of other types, such as sensors based on indirect ToF.

Proximity sensor 100 comprises a first optical multimode fiber 102 with an emitting fiber end 122, a second optical multimode fiber 104 with a receiving fiber end 124, an emitter 106 of optical radiation, and a detector 108 of optical radiation. Emitter 106 comprises a vertical-cavity surface-emitting laser (VCSEL) or other radiation source emitting short optical pulses. Detector 108 emits electrical signals indicative of times of flight of the optical pulses. For this purpose, for example, detector 108 comprises a single-photon avalanche diode (SPAD), emitting a single electronic pulse for each received photon. Sensor 100 in this example is incorporated in a portable electronic device with a cover glass 110, which typically covers the frontal area of the portable device. Fiber ends 122 and 124 are positioned in proximity to cover glass 110. In the pictured embodiment, an optical bandpass filter 125 is positioned between second multimode fiber 104 and detector 108 for rejecting a part of ambient radiation entering the second fiber.

A processor 112 controls the emission of optical pulses from emitter 106 and processes the signals output by detector 108. Processor 112 typically comprises analog and digital signal processing components for extracting and measuring the time of flight of the optical pulses. Additionally or alternatively, at least some of the functions of processor 112 may be carried out in software, for example by a programmable microprocessor or microcontroller.

For measuring the distance to object 128, emitter 106 emits a beam of short optical pulses into first optical fiber 102, shown schematically by an arrow 114. First optical fiber 102 conveys the radiation to emitting end 122, and directs the beam of radiation, as shown by an arrow 130, through cover glass 110 toward object 128. A portion of the reflected beam, shown by an arrow 132, enters second optical fiber 104 through receiving end 124 and is conveyed by the fiber to detector 108, as shown by an arrow 136. Detector 108 emits an electronic pulse for each received photon. These pulses are read by processor 112, which computes the distance to object 128 based on the time delay between emission of a pulse from emitter 106 and detection of the pulse by detector 108.

The structure of proximity sensor 100 permits a large gap, for example several millimeters, in the z-direction between an optoelectronic assembly 138 of the proximity sensor and cover glass 110. (Optoelectronic assembly 138 comprises emitter 106 and detector 108 with their respective electronics.) This gap, shown by a double arrow 140, is bridged by fibers 102 and 104, thus relaxing the constraints of the opto-mechanical design of proximity sensor 100. Furthermore, were fibers 102 and 104 not used, any gap 120 exceeding a few hundreds of microns would lead to a significant portion of the optical radiation emitted from emitting end 122 to reflect from cover glass 110 directly into receiving end 124 and thus into detector 108. This, in turn, would lead to a deterioration of the quality of the signal output by the detector and thus to a potentially erroneous reading of the distance to target 128.

As will be further detailed hereinbelow, each of fibers 102 and 104 is constructed as a multimode fiber, providing a large optical aperture for ease of alignment and with a numerical aperture (NA) large enough to transmit and capture optical radiation over the angular range of interest. The fibers are constructed, however, so as to have an NA not exceeding 0.5, and in some embodiments even 0.2 or less, so as to minimize the optical crosstalk between the first and second optical fibers 102 and 104, respectively. Furthermore, having a low NA for second optical fiber 104 relaxes the design requirements for optical bandpass filter 125 used to reject ambient illumination. For example, for second fiber 104 having an NA of 0.5 and a typical design for bandpass filter 125 with a center wavelength of 940 nm and a passband of 30 nm, the combined effect of the limited NA and narrow passband is to allow only approximately 1% of the wide-angle, broad-spectrum ambient light that enters the second fiber to reach detector 108.

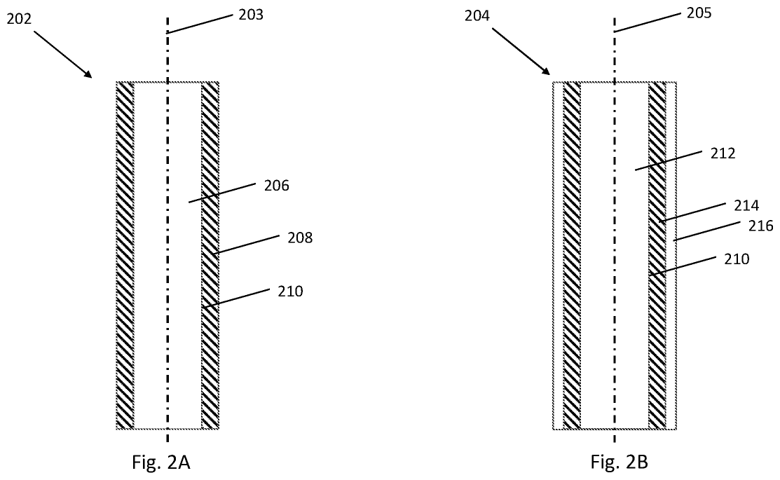

FIGS. 2A and 2B are schematic longitudinal sectional views of optical fibers 202 and 204, in accordance with embodiments of the invention. Either of optical fibers 202 and 204 may be used in place of fibers 102 and 104 in proximity sensor 100 (FIG. 1).

Optical fibers 202 and 204 are cylindrically symmetrical around respective axes 203 and 205, and have sufficiently large diameters to function as multimode optical fibers. Optical fiber 202 is a two-component fiber, comprising a core 206 and a cladding 208. Core 206 comprises poly-methyl-methacrylate (PMMA), while cladding 208 comprises polyvinylidene difluoride (PVDF), for example. As the refractive index of PMMA is higher than that of PVDF, optical rays propagating in core 206 at a sufficiently small angle with respect to axis 203 are reflected at a core/cladding interface 210 by total internal reflection (TIR). The NA of the rays exiting from fiber is limited by the difference between the refractive indices of PMMA and PVDF to a typical value not exceeding 0.5.

Optical fiber 204 is a three-component fiber, comprising a core 212, a first cladding 214, and a second cladding 216. Core 212 and first cladding 214 comprise respectively, similarly to fiber 202, PMMA and PVDF. Second cladding 216 comprises PMMA. The propagation of light within fiber 204 is determined, similarly to fiber 202, by the difference between the refractive indices of PMMA and PVDF. Second cladding 216 adds resilience to fiber 204, and facilitates attaching the fiber to external structures by cementing, for example. Furthermore, second cladding 216 reduces light leakage by those high-angle rays that have entered from core 212 into first cladding 214.

One advantage of plastic optical fibers, such as fibers 202 and 204, as compared to fibers fabricated from brittle materials, such as glass, is their higher reliability in portable electronic devices. For example, plastic fibers are less likely to shatter than glass fibers if the portable device is dropped. Furthermore, plastic fibers may be easily formed to curved shapes, as will be detailed hereinbelow, by heating them to appropriate temperatures.

By a suitable choice of the materials for core and cladding, the NA of the fiber may be reduced from 0.5, down to 0.2 or less. For alternative embodiments, for example, the material for fiber core 206 or 212 may be selected from the following list of materials: PMMA, polycarbonate (PC), polyester (PE), polyethylene terephthalate glycol-modified (PETg), or cyclic olefin polymer (COP). Similarly, the material for claddings 208, 214, and 216 may be selected from the following list of materials: PVDF, a terpolymer (comprising ethylene, tetrafluoroethylene, and hexafluoropropylene), PMMA, PETg, PC, polystyrene (PS), COP, or co-polymers of the above. For example, fibers with NA of 0.48, 0.39, 0.31, and 0.18 may be constructed with core/cladding polymer combinations of PMMA/PVDF, COP/PMMA, PE/PC, and PC/PS, respectively.

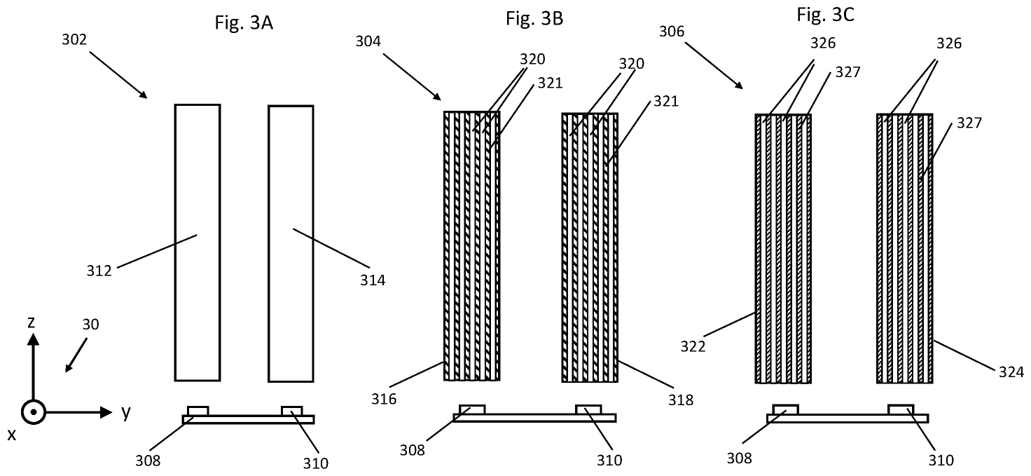

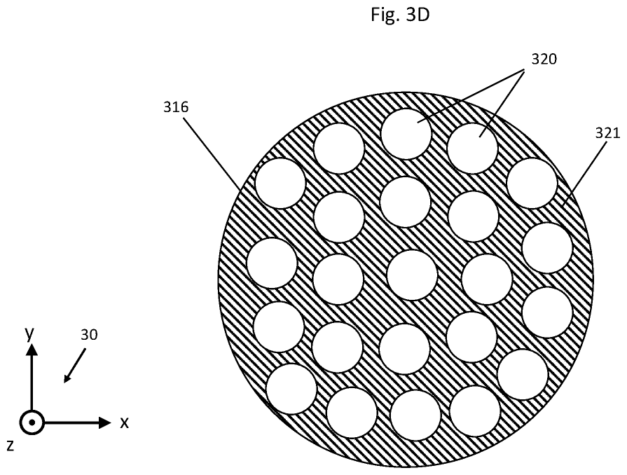

FIGS. 3A, 3B, and 3C are schematic partial sectional views of three proximity sensors 302, 304, and 306, in accordance with embodiments of the invention, while FIG. 3D is a schematic cross-sectional view of an optical fiber 316 used in proximity sensor 304. Each proximity sensor 302, 304, and 306 comprises an emitter 308 and a detector 310 (similarly to emitter 106 and detector 108 in FIG. 1), with the respective first and second optical fibers of each sensor aligned with the corresponding emitter and detector. For the sake of simplicity, processor (such as processor 112 in FIG. 1) and cover glass 110 have been omitted from these figures.

Proximity sensor 302 (FIG. 3A) comprises a first optical fiber 312 and a second optical fiber 314. Both fibers 312 and 314 are single-core fibers similar to fiber 202 (FIG. 2A) or fiber 204 (FIG. 2B). A typical diameter of the core of the fibers is 600 microns, and a typical thickness of the cladding is 50 microns, although larger or smaller dimensions may alternatively be used. The rays propagating in first fiber 312 are confined by the core-cladding interface. However, large-angle rays can pass through the cladding and enter second fiber 314, possibly causing crosstalk between the emitted and received optical radiation.

Proximity sensor 304 (FIG. 3B) comprises a first optical fiber 316 and a second optical fiber 318. Both fibers comprise multiple sub-fibers 320. As shown in FIG. 3D, sub-fibers 320 comprise respective fiber cores, which are surrounded by a cladding 321. These cores together with cladding 321 form multiple fibers, each similar to fiber 202 (FIG. 2A). A typical diameter of the core of each sub-fiber 320 is 40 microns, and a typical outer diameter of each fiber 316 and 318 is 600 microns, although in this embodiment, too, larger or smaller diameters may be used. The diameter of each sub-fiber 320 is sufficiently large so that the sub-fibers function as multimode fibers. The rays propagating in first fiber 316 are confined partially by the core-cladding interfaces and partially by cladding 321. However, some large-angle rays can still pass through cladding 321 and enter second fiber 318, causing crosstalk. An advantage of a multi-core fiber, such as fibers 316 and 318 with multiple sub-fibers 320, over a single core fiber, such as fibers 312 and 314, is that the optical coupling of a multi-core fiber with an optical emitter and/or a detector is less sensitive to the alignment of the fiber in the xy-plane.

Proximity sensor 306 (FIG. 3C) comprises a first optical fiber 322 and a second optical fiber 324. Both fibers comprise multiple sub-fibers 326, with each sub-fiber having a core surrounded by a two-component cladding 327, comprising a first cladding and a second cladding (not shown separately) similarly to fiber 204 (FIG. 2B). A typical diameter of each sub-fiber 326 is 40 microns (forming again multimode fibers), and a typical outer diameter of each fiber 322 and 324 is 600 microns. The rays propagating in first fiber 322 are confined by core-cladding interface of each sub-fiber 326. Large-angle rays are mostly suppressed in this fiber structure, reducing the level of cross-talk between first fiber 322 and second fiber 324 to a very low level.

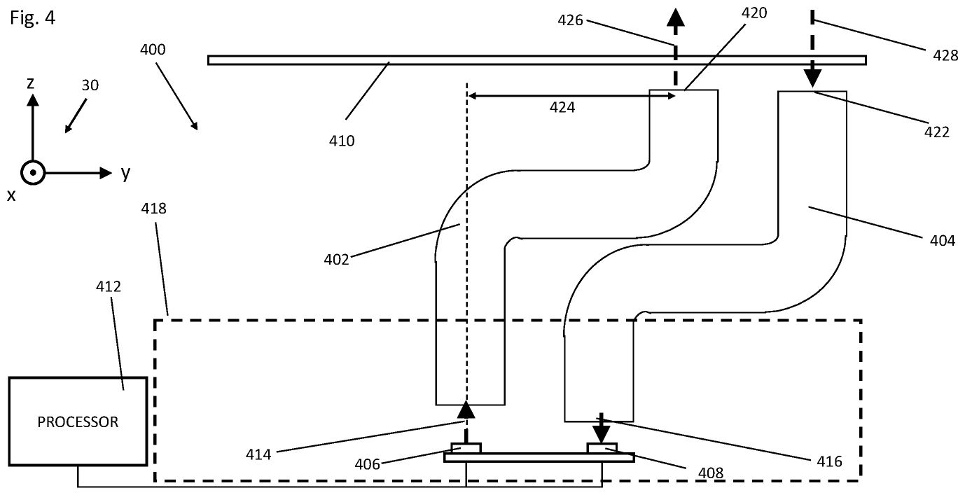

FIG. 4 is a schematic sectional view of a proximity sensor 400, in accordance with another embodiment of the invention.

Proximity sensor 400 comprises a first optical fiber 402, a second optical fiber 404, an emitter 406 of optical radiation, a detector 408 of optical radiation, and a cover glass 410. An emitting end 420 of first optical fiber 402 and a receiving end 422 of second optical fiber 404 face cover glass 410 in close proximity. A processor 412 is similar to processor 112 (FIG. 1) with respect to its functions and structure.

Proximity sensor 400 is similar to proximity sensor 100 (FIG. 1), with the main difference being the shape of first and second optical fibers 402 and 404, as compared to optical fibers 102 and 104: First optical fiber 402 is bent so as to generate a lateral offset 424 in the y-direction between emitting end 420 and emitter 406, rather than being straight as first optical fiber 102. Thus the optical radiation emitted by emitter 406, shown by an arrow 414, exits from emitting end 420 and shown by an arrow 426 with offset 424 to emitted radiation 414. Second optical fiber 404 is similarly bent to generate a lateral offset between received radiation, shown by an arrow 428, and detector 408, with an arrow 416 indicating the received radiation impinging on the detector.

Optical fibers 402 and 404 are multimode fibers, which may comprise multiple sub-fibers, as described with reference to FIGS. 3A, 3B, and 3C hereinabove.

Although in the pictured embodiment first and second optical fibers 402 and 404 are bent so as to generate offsets in the y-direction, in alternative embodiments the optical fibers may be bent so as to generate offsets in a general xy-direction. In further embodiments, first and second optical fibers 402 and 404 may be bent so as to generate different offsets for the first and second optical fibers, thus enabling a spacing between emitter 406 and detector 408 that differs from the spacing between emitting end 420 and receiving end 422.

The various offsets generated by bending first and second optical fibers 402 and 404 enable a relaxation of the requirements for both the positioning and the internal structure of an assembly 418 comprising emitter 406 and detector 408 with their respective electronics. This kind of relaxation is advantageous in the optomechanical design of devices such as portable electronic devices, which typically have demanding space constraints.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A proximity sensor, comprising:
a light source configured to emit a beam of optical radiation;
a detector configured to output an electrical signal in response to the optical radiation that is incident on the detector;
a first optical multimode fiber configured to receive the emitted beam and to direct the emitted beam toward an object;
a second optical multimode fiber configured to receive the optical radiation reflected from the object and to convey the received optical radiation to the detector; and
a processor coupled to process the electrical signal so as to compute a distance to the object.

2. The sensor according to claim 1, wherein the light source is configured to output pulses of the optical radiation, and the electrical signal output by the detector is indicative of a time of flight of the optical pulses, and the processor is configured to compute the distance to the object based on the time of flight.

3. The sensor according to claim 1, wherein the first and second optical multimode fibers comprise plastic optical fibers.

4. The sensor according to claim 3, wherein each of the plastic optical fibers comprises a core comprising a core material selected from a first list consisting of polymethylmethacrylate (PMMA), polycarbonate (PC), polyester (PE), polyethylene terephthalate glycol-modified (PETg), and cyclic olefin polymer (COP), and at least one cladding comprising at least one cladding material selected from a second list consisting of polyvinylidene difluoride (PVDF), a terpolymer comprising ethylene, tetrafluoroethylene, and hexafluoropropylene, PMMA, PETg, PC, polystyrene (PS), COP, and co-polymers of these polymers.

5. The sensor according to claim 4, wherein the core comprises PMMA, and wherein the at least one cladding comprises a first cladding comprising PVDF and a second cladding comprising PMMA.

6. The sensor according to claim 1, wherein each of the first and second optical multimode fibers comprises a respective plurality of multimode sub-fibers.

7. The sensor according to claim 6, wherein each sub-fiber comprises a core and at least one cladding.

8. The sensor according to claim 1, wherein the numerical aperture (NA) of each of the first and second optical multimode fibers does not exceed 0.5.

9. The sensor according to claim 8, wherein the NA of each of the first and second optical multimode fibers does not exceed 0.2.

10. The sensor according to claim 1, wherein at least one of the first and second optical multimode fibers is bent so as to deviate from a straight line.

11. The sensor according to claim 1, wherein the first optical multimode fiber is configured to direct the beam of the optical radiation toward the object through a cover glass, and the second optical multimode fiber is configured to receive the optical radiation reflected from the object through the cover glass.

12. The sensor according to claim 1, wherein the distance does not exceed 100 cm.

13. A method for proximity sensing, comprising:
directing a beam of optical radiation from a light source through a first optical multimode fiber toward an object;
receiving the optical radiation reflected from the object in a second optical multimode fiber and conveying the received optical radiation through the second optical multimode fiber to a detector; and
processing an electrical signal output by the detector in response to the received optical radiation so as to compute a distance to the object.

14. The method according to claim 13, wherein directing the beam of optical radiation comprises directing a beam of pulses of the optical radiation, and wherein processing the electrical signal comprises processing the electrical signal to compute the distance to the object based on a time of flight of the pulses.

15. The method according to claim 13, wherein the first and second optical multimode fibers comprise plastic optical fibers.

16. The method according to claim 13, wherein each of the first and second optical multimode fibers comprises a respective plurality of multimode sub-fibers.

17. The method according to claim 13, wherein the numerical aperture (NA) of each of the first and second optical multimode fibers does not exceed 0.5.

18. The method according to claim 17, wherein the NA of each of the first and second optical multimode fibers does not exceed 0.2.

19. The method according to claim 13, and comprising bending at least one of the first and second optical multimode fibers so as to deviate the at least one of the first and second optical multimode fibers from a straight line.

20. The method according to claim 13, wherein directing the beam of optical radiation toward the object comprises directing the beam from the first optical multimode fiber through a cover glass, and wherein receiving the optical radiation reflected from the object comprises receiving the radiation through the cover glass into the second optical multimode fiber.
